(19) United States
(12) Patent Application Publication
(10) Pub. No.: US 2004/0020249 A1
(43) Pub. Date: Feb. 5, 2004

(54) Overload safety device and method for the production thereof

(76) Inventors: Jens Battermann, Weil der Stadt (DE); Stephan Gaertner, Hamburg (DE); Torsten Harms, Hamburg (DE); Joerg Haertel, Neu Wulmstorf (DE); Axel Hebenstreit, Stuttgart (DE); Torsten Kirchner, Tostedt (DE); Holger Kittler, Hamburg (DE); Hanno Lox, Elmshorn (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/312,636

(22) PCT Filed: Jun. 23, 2001
(86) PCT No.: PCT/EP01/07155

(30) Foreign Application Priority Data
Jun. 30, 2000 (DE) 100 31 902.5

(51) Int. Cl. B60R 25/02; F16C 3/00; G05G 5/00

(52) U.S. Cl. 70/186

(57) ABSTRACT

An overload safeguard on a joining connection and a method for producing the overload safeguard are provided. The joining connection comprises an outer joining part having a through-opening and a cylindrical, inner joining part which is acted upon by torque, protrudes through the through-opening in the outer joining part and is frictionally connected to the latter. A countertorque of equal magnitude to the torque of the inner joining part acts on the outer joining part in such a manner that when a torque value corresponding to the maximum permissible frictional force is exceeded, the frictional connection is released and the inner joining part slips in the connection. The inner joining part forms a press fit with the outer joining part and, with its outer circumference, bears against the inner circumference of the through-opening in the outer joining part with a pre-stressing force corresponding to the torque value.

The invention relates to an overload safeguard according to the precharacterizing clause of Patent claim 1 and to a method for its production according to the precharacterizing clause of Patent claim 6.

An overload safeguard of the generic type and a method for its production are disclosed in EP 0 569 269 A1. In this case, a clamping ring which forms the outer joining part is slid onto a steering spindle constituting the inner, cylindrical joining part, the said clamping ring interacting with a clamping bolt of a steering wheel lock in order to avoid unauthorized use of the motor vehicle. At least one friction ring is arranged between the inner joining part and the outer joining part, the said frictional ring being supported on one side on the inner joining part and on the other side on the outer joining part. For retention of the friction ring, the inner joining part (FIG. 2) has a peripheral groove in which the ring is held. Another possibility is reproduced by the example of FIG. 3 or FIG. 4, in which the outer joining part has, on the inner circumference, a freely turned recess which holds the friction ring. The friction ring is of elastic design and between the two joining parts produces, firstly, a frictional connection and, secondly, compensation for tolerances should the two joining parts be uneven. The frictional connection is designed in such a manner that when the clamping bolt engages in the clamping ring, the torque of the steering spindle is counteracted by a countertorque, via the clamping ring, so that the rotation of the steering spindle and therefore of the steering wheel is opposed by a high resistance, as a result of which the rotation of the steering wheel turns out to be very stiff and therefore safe control of the vehicle during driving is rendered impossible. If a certain torque value is exceeded, the frictional connection is released, so that the steering spindle slips in the clamping ring, as a result of which deformation or fracturing of the steering spindle is prevented. A disadvantage of the known method is that when the two joining parts are slid together onto each other, the friction ring which is fitted on one of the two joining parts is squeezed by the frictional connection, which is already produced during the sliding-on process, and the axial tension associated with the frictional connection and through the sliding movement, and can be damaged. In addition, an undesirably high prestressing force of the friction ring is produced, so that the torque value, above which the joining system is intended to slip, is increased in an impermissible and uncontrolled manner. Furthermore, the outlay on machining the joining parts during installation in order to hold the friction ring is considerable.

The invention is based on the object of developing a generic overload safeguard and a method for its production to the effect that the overload safeguard can be produced with little outlay and the frictional connection can be set at a specific level in a simple manner.

According to the invention, the object is achieved with regard to the overload safeguard by the features of Patent claim 1 and with regard to the production method by the features of Patent claim 6.

The invention permits a friction ring to be omitted by virtue of the press fit obtained in the joining connection, as a result of which the multiplicity of parts of the overload safeguard, and therefore of the assembly of the steering column, is reduced, which brings about a reduction in the weight. The desired press fit, and therefore the overload safeguard, can be achieved just with a little outlay. Furthermore, the production costs and the outlay on production are produced, since mechanical machining of the inner joining part and/or the outer joining part in order to hold a friction ring is rendered superfluous. The production of the respective joining part, and therefore also that of the overload safeguard, is simplified in this respect. In addition, the complicated installation of the friction ring, which is susceptible to wear, is not needed. This in turn means an improvement in the long-term durability of the overload safeguard. The strength of the frictional connection, which is substantially responsible for the functioning of the overload safeguard, can be set at a very specific level by varying the press-on force, and can be customized precisely to the particular application and requirements. As seen overall, the invention permits the formation of an extremely simple, but nevertheless highly reliable and practical overload safeguard on a joining connection.

Expedient refinements of the invention can be gathered from the subclaims: otherwise, the invention is explained in greater detail below with reference to an exemplary embodiment illustrated in the drawing, in which:

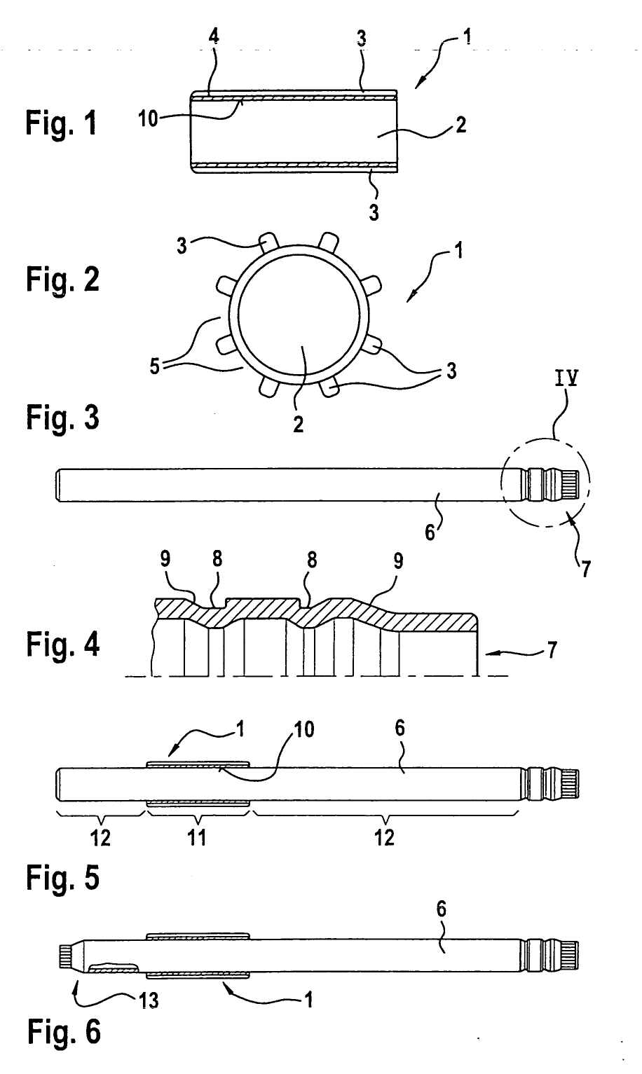

FIG. 1 shows an outer joining part of a component having an overload safeguard according to the invention in a lateral longitudinal section,

FIG. 2 shows the joining part from FIG. 1 in a front view,

FIG. 3 shows an inner joining part of a component having an overload safeguard according to the invention in a lateral view,

FIG. 4 shows a cutout of the inner joining part from FIG. 3 in a lateral longitudinal section,

FIG. 5 shows the joined component having the overload safeguard according to the invention after production of the joining connection between the outer joining part according to FIG. 1 and the inner joining part according to FIG. 3, in a lateral longitudinal section,

FIG. 6 shows the joined component having the overload safeguard according to the invention in a completed state.

FIG. 1 illustrates an outer joining part 1 of a component having an overload safeguard on a joining connection, the said outer joining part having a through-opening 2 and radial webs 3 which run along the longitudinal extent of the joining part 1 and are arranged offset with respect to one another in the circumferential direction (FIG. 2). In the application shown here, the outer joining part 1 forms a clamping ring which interacts with the locking element of a steering wheel lock, the overload safeguard being integrated into a device securing against the unauthorized use of vehicles. The clamping ring is designed in a simple manner as a sleeve-shaped extruded profile which, as a mass-produced part, is cut to size from an endless profile. Owing to the invention, the use of the extruded profile does not require any complicated finishing work. On the outer circumference 4, the clamping ring has engagement grooves 5 which run axially between the webs 3 and in which the locking element of the steering wheel lock can engage in a retaining manner. As a alternative to extrusion, the outer joining part 1 may also be impact-extruded or formed by internal high pressure from a rectilinear, cylindrical starting form into a final form configured with an engagement groove 5. The latter method is favourable if the precise outer contour is important, for example if the locking element of the steering wheel lock engages in the engagement grooves 5 with the guarantee that it will not jam.

The component, which forms a steering column here, for example, furthermore has, in the joining connection, a cylindrical, inner joining part 6 (FIG. 3) which constitutes a steering spindle of the steering column. The joining part 6 is hollow and therefore of low weight in comparison with solid designs yet with high stiffness simultaneously being ensured. A plurality of recesses 8 and conical surfaces 9 are formed at one end 7 of the inner joining part 6 for connecting the steering spindle to the steering gear (FIG. 4). The steering spindle, i.e. the hollow, inner joining part 6, can itself be a part formed by internal high pressure, in which case a rectilinear, cylindrical tube is placed into a forging die and is expanded under high fluidic internal pressure into its preliminary end form according to FIGS. 3 and 4 in accordance with the engraved shape of the forging die.

According to FIG. 5, the inner joining part 6 is fed into the through-opening 2 in the outer joining part 1, so that the inner joining part 6 protrudes through the outer joining part 1. The two joining parts 1 and 6 are then pressed together in this sliding position. The pressing can take place by shrinking the outer joining part 1 onto the inner joining part 6 or else, in an advantageous manner, can take place without the influence of thermal energy, by expansion of the inner joining part 6, in which case that section 11 of the inner, hollow joining part 6 which is placed at the location of the press fit to be formed is plastically expanded relative to the diameter of the through-opening 2 in the outer joining part 1, which diameter remains approximately the same, and is pressed onto the inner side 10 of the outer joining part 1, which springs back elastically after the expansion. The joining part 6 therefore bears, with its outer circumference, against the inner circumference of the through-opening 2 in the outer joining part 1. The expansion can be brought about by broaching or opening out the corresponding location of the inner joining part 6.

A rapid and reliable expansion method, which also just as exactly reproduces the frictional connection, is the method involving partial formation by internal high pressure. In this case, an expansion lance is slid into the cavity of the inner joining part 6, the expansion lance having an axial duct for guiding a fluidic medium which is under high pressure, the said axial duct having a radial hole which is positioned at the location of the expansion to be produced. The radial hole is sealed in both axial directions in a manner resistant to high pressure (>approximately 500 bar) by means of two radial seals arranged on the circumference of the expansion lance on both sides of the hole outlet. This means that the internal high pressure only acts on that point of the inner joining part 6 which lies between the two radial seals. By controlling the high pressure of the fluid, the press-on pressure, and therefore the strength of the frictional connection, can be set in an extremely precise manner, depending on requirements and, of course, within the scope of the ductile yield of the inner joining part 6 and of the elasticity of deformation of the outer joining part 1. The inner joining part 6 therefore expands plastically until it extensively and fixedly bears against the inner side 10 of the outer joining part 1. The outer joining part 1 also expands temporarily, but only in the elastic range, so that after the pressure is relieved, the material of the outer joining part 1 springs elastically towards the plastically expanded, inner joining part 6, as a result of which there is a high frictional connection between joining parts 1 and 6.

The local design of the frictional connection can be based on a plurality of alternatives. Firstly, the frictional connection can be formed locally just in a pointwise manner, for which purpose the inner joining part 6 is pressed peripherally onto the outer joining part 1 at at least one axial position within the extent of the outer joining part 1, which makes the production particularly rapid, in particular in the case of an expansion method—used on the inner joining part 6. Secondly, the inner joining part 6 can be expanded along the entire axial region of extent of the through-opening 2 in the outer joining part 1. In this case, the support of the outer joining part 1 on the joining part 6, i.e. the joining connection overall, is advantageous with regard to its fatigue strength, since torques acting on the joining connection are broadly distributed over the extent of the outer joining part 1. Furthermore, it is conceivable to join the joining parts 1 and 6 in a closed internal high pressure forming mould. In this connection, not only that section 11 of the inner joining part 6 which is placed at the location of the press fit to be produced, but also the sections 12 lying outside the outer joining part 1 can be expanded. This results in the outer joining part 1 being embedded into the inner joining part 6 in a form-fitting manner in the axial direction, and therefore in a particularly good, non-slip, axial support. If the expansion is restricted only to the overlapping section of the inner joining part 6 with the outer joining part 1, a joining connection or component formation which saves on structural space in comparison with the last-mentioned variant can be achieved. A closed internal high pressure forming mould is not required for this, and so the use of the abovementioned expansion lance is sufficient.

After the formation of the desired press fit according to the invention, in the event of internal high pressure having been applied, the latter is relieved and the expansion lance is pulled out of the inner joining part. If the joining connection is used in the steering column, the end 13 which is remote from the steering gear and is in the vicinity of the steering wheel is, according to FIG. 6, appropriately finished for the purpose of installing the steering wheel on the steering spindle by the end 13 being tapered and corrugated circumferentially.

The overload safeguard on the joining connection described acts as follows, taking the example of the steering spindle. The joining part 6, the steering spindle, which is acted upon by torque, is frictionally connected to the clamping ring, the outer joining part 1, by pressing them directly together. If now in the closed state of the steering wheel lock, in which a locking element engages in an engagement groove 5 of the clamping ring, the steering wheel—and, connected therewith, the steering spindle—is rotated, then the torque of the steering spindle is counteracted by a torque of equal magnitude to it via the locking resistance of the locking element engaging in the clamping ring. In order to avoid the steering spindle being deformed or damaged in another manner at too high a torque and therefore being unusable for further use in the driving mode for the correct vehicle driver, the frictional connection between the steering spindle and clamping ring is set in such a manner that when a torque value corresponding to the maximum permissible frictional force is exceeded, the frictional connection is released and the steering spindle slips in the connection. In this connection, it should be noted once again that by means of the regulation of the internal high pressure in a manner enabling it to be controlled in a highly precise manner, the matching, maximum torque value can advantageously be set very exactly and, similarly, in a simple manner—with just one mould and merely by regulating the pressure—can be widely varied to suit diverse application purposes. The steering spindle therefore bears against the clamping ring with a prestressing force corresponding to the predetermined torque value. The torque value determined here for steering-spindle applications lies in the range of between 120 and 190 Nm. Below 120 Nm, the steering spindle would be impermissibly too easy to move and above 190 Nm, the steering spindle would, as mentioned, be damaged.

The field of application for the overload safeguard according to the invention is to be regarded as being very wide. In this connection, all of the joining connections on tubular base bodies, for example in the case of axles, shafts and supports, which have to slip at a defined load can be taken into consideration.

1. Overload safeguard on a joining connection which comprises an outer joining part having a through-opening and a cylindrical, inner joining part which is acted upon by torque, protrudes through the through-opening in the outer joining part and is frictionally connected to the latter, a countertorque of equal magnitude to the torque of the inner joining part acting on the outer joining part in such a manner that when a torque value corresponding to the maximum permissible frictional force is exceeded, the frictional connection is released and the inner joining part slips in the connection, and the inner joining part forming a press fit with the outer joining part and, with its outer circumference, bearing against the inner circumference of the through-opening in the outer joining part with a prestressing force, characterized in that the inner, hollow joining part (6) is plastically expanded in the press fit to the outer joining part (1) relative to its state in the unpressed sliding position, and in that the outer joining part (1) is elastically expanded in the press fit, the inner joining part (6) bearing against the outer joining part (1) with a prestressing force corresponding to the torque value.

2. Overload safeguard according to claim 1, characterized in that that section (11) of the inner joining part (6) which is placed at the location of the press fit is expanded relative to the sections (12) lying outside the outer joining part (1).

3. Overload safeguard according to either of claims 1 and 2, characterized in that the inner joining part (6) is expanded along the entire axial extent of the through-opening (2) in the outer joining part (1).

4. Overload safeguard according to one of claims 1 to 3, characterized in that the overload safeguard is integrated in a device securing against the unauthorized use of vehicles, in that the outer joining part (1) is a clamping ring interacting with the locking element of a steering wheel lock, and in that the inner joining part (6) is formed by a steering spindle of a steering column.

5. Overload safeguard according to claim 4, characterized in that the clamping ring is a sleeve-shaped extruded profile having engagement grooves (5) which are formed on the outer circumference and run axially.

6. Method for producing an overload safeguard on a joining connection, an inner, cylindrical joining part which is acted upon by torque being slid into a through-opening in an outer joining part and being frictionally connected to the latter, a frictional connection between the inner joining part and the outer joining part, on which a countertorque of equal magnitude to the torque of the inner joining part acts, being set in such a manner that when a torque value corresponding to the maximum permissible frictional force is exceeded, the frictional connection is released and the inner joining part slips in the connection, and the inner joining part being pressed together with the outer joining part with a prestressing force of the inner joining part against the joining part, characterized in that the pressing together takes place in the sliding position of the two joining parts (1 and 6), that section (11) of the inner, hollow joining part (6) which is placed at the location of the press fit to be formed being plastically expanded relative to the diameter of the through-opening (2) the outer joining part (6), which diameter remains approximately the same, and being pressed against the inner side (10) of the outer joining part (6), which springs back elastically after the expansion with a prestressing force corresponding to the torque value.

7. Method according to claim 6, characterized in that the inner joining part (6) is expanded peripherally at at least one axial position within the extent of the outer joining part (1) by means of fluidic internal high pressure.

8. Method according to either of claims 6 and 7, characterized in that the inner joining part (6) is expanded along the entire axial region of extent of the through-opening (2) of the outer joining part (1) and is pressed onto the latter.

9. Method according to one of claims 6 to 8, characterized in that the inner joining part (6) is additionally expanded outside the axial region of extent of the outer joining part (1) by means of internal high pressure.

10. Method according to one of claims 6 to 9, characterized in that the outer joining part (1) is extruded or impact-extruded.

11. Method according to one of claims 6 to 10, characterized in that the outer joining part (1) is formed by internal high pressure from a rectilinear, cylindrical starting form into an end form configured with an engagement groove (5).
